(19) United States
(12) Patent Application Publication
(10) Pub. No.: US 2009/0295537 A1
(43) Pub. Date: Dec. 3, 2009

(54) VEHICLE TRANSFER PROCESS

(76) Inventors: Robert Lane, Brighton (AU); Mark Suhr, South Yarra (AU)

Correspondence Address: DLA PIPER US LLP, 1999 AVENUE OF THE STARS, SUITE 400, LOS ANGELES, CA, 90067-6023, US

(21) Appl. No.: 11/719,294

(22) PCT Filed: Nov. 17, 2005
(86) PCT No.: PCT/AU05/01749

§ 371 Date: Feb. 17, 2009

(30) Foreign Application Priority Data
Nov. 18, 2004 (AU) 2004906574
Feb. 17, 2005 (AU) 2005900734
Mar. 4, 2005 (AU) 2005901038
Apr. 7, 2005 (AU) 2004901715

(51) Int. Cl. G06F 7/04; H04Q 5/22; G06F 12/14; H04L 9/00

(52) U.S. Cl. 340/5.82; 340/10.1; 713/189; 713/160

(57) ABSTRACT

A method of tracking a vehicle during a transfer process that includes one or more stages. The method involves utilising a tag having a tag data store, and uses a tag reader to determine an identifier from the tag data store, and then uses this to determine transfer information at least partially indicative of an identity of the vehicle and a status of the transfer process. The transfer information is then used to locate the vehicle, confirm that a stage in the transfer is to proceed or determine the status of the transfer.

### BACKGROUND OF THE INVENTION

The present invention relates to a method and apparatus for tracking a vehicle during a transfer process, and in particular for tracking a vehicle during an export process.

### DESCRIPTION OF THE ART

The reference to any prior art in this specification is not, and should not be taken as, an acknowledgment or any form of suggestion that the prior art forms part of the common general knowledge.

Currently there is a need to be able to accurately identify and determine information related to vehicles including automobiles. Whilst this has previously been achieved using printed serial numbers on particular parts of the vehicle, such techniques have a number of drawbacks, including a number of serial numbers being disposed at different locations on or in the vehicle, and the ability for serial numbers to be fraudulently changed or interchanged.

Furthermore, such serial numbers require close up inspection, and this is therefore unsuitable for allowing vehicles to be located rapidly.

RFID systems have been developed which utilise a tag to store an identifier. The tag can be read using an associated reader, allowing the identifier to be retrieved and corresponding items determined. However in most systems the volume of data that can be stored on the tag is limited to an identifier, and whilst this can be used to identify a vehicle, its use is limited.

The problem of vehicle identification is particularly exacerbated in export processes. In particular, many vehicles are involved, and the process of identifying vehicles in storage yards or the like can be difficult and time consuming. Furthermore, vehicles can be left unattended for long periods of time, thereby providing the opportunity for vehicle details, such as chassis numbers and VINs (Vehicle Identification Numbers) to be fraudulently altered. Even assuming that vehicles can be identified, there are a large number of checks that must be performed on the vehicle, and following the vehicle through this process is complex and time consuming.

### SUMMARY OF THE PRESENT INVENTION

In a first broad form the present invention provides a method of tracking a vehicle during a transfer process, the transfer process including one or more stages, the method utilising a tag having a tag data store, and wherein the method includes:
a) in a tag reader:
   i) determining an identifier from the tag data store;
   ii) determining, using the identifier, transfer information at least partially indicative of:
      (1) an identity of the vehicle; and,
      (2) a status of the transfer process; and,
b) using the transfer information, to at least one of:
   (1) locate the vehicle;
   (2) confirm that a stage in the transfer is to proceed; and,
   (3) determine the status of the transfer.

Typically the identifier is at least one of:
a) the vehicle identity; and,
b) a reference number mapped to the vehicle identity.

Typically the method includes, in the tag reader, determining the transfer information from at least one of:
a) a remote database; and,
b) the tag data store.

Typically the tag forms part of an identity card provided in the vehicle.

Typically the method includes, in the tag reader:
a) determining, using the identifier and from a remote database, the transfer information; and,
b) displaying the transfer information.

Typically the vehicle is stored in a storage location, and wherein the method includes, in the tag reader:
a) receiving an indication of a vehicle identity;
b) determining the identifier associated with the vehicle identity; and,
c) detecting the tag using the determined identifier to thereby locate the vehicle.

Typically the method includes, in the tag reader:
a) adjusting a read range of the tag reader,
b) determining if the identifier can be read from any tags within the read range; and,
c) repeating steps a) and b) to thereby locate the tag.

Typically the method includes, in the tag reader:
a) determining from user input, an updated status; and,
b) updating the transfer information based on the updated status.

Typically the method includes, performing a stage in the transfer process by:
a) using the tag reader to:
   i) locate the vehicle; and,
   ii) display the transfer information;
b) performing a clearance inspection, at least in part by comparing at least one of the vehicle and the transfer information to clearance criteria; and,
c) in response to a successful clearance, performing at least one of:
   i) updating the transfer information using the tag reader;
   ii) continuing the vehicle transfer process; and,
   iii) returning the vehicle a storage location and updating the transfer information with the new location.

Typically the method includes, in a processing system, updating the transfer information by adding details of at least one of:
a) a clearance number;
b) an agent identity;
c) an inspection date;
d) an inspection time;
e) an inspection number;
f) any clearance restrictions;
g) an intended destination; and,
h) details of required modifications.

Typically the method includes, in a processing system:
a) determining completion of the transfer process; and,
b) disassociating the tag and the vehicle in response to a successful determination.

Typically the method includes, in a processing system, causing the transfer information to be locked as it is stored or updated.

Typically the method includes, locking the information at least in part by encrypting the transfer information such that the transfer information can only be decrypted using a secret key.

Typically the method includes, in a tag reader:
a) determining an operator identifier indicative of an identity of an operator;
b) authenticating the operator using the operator identifier; and,
c) in response to a successful authentication, at least one of:
   i) determining the identifier;
   ii) determining the transfer information; and,
   iii) modifying the transfer information.

Typically the method includes, in the tag reader:
a) receiving the operator identifier from the operator;
b) comparing the operator identifier to a number of predetermined operator identifiers stored in a data store; and,
c) authenticating the operator in response to a successful comparison, wherein the operator identifier includes at least one of:
   i) a biometric signature;
   ii) a password; and,
   iii) a PIN.

Typically the method includes, in the tag reader:
a) determining from the transfer information at least one transfer information access level;
b) determining, using the operator identifier and from operator details stored in a data store, one or more operator access levels;
c) comparing the transfer information access levels to the operator access levels; and,
d) selectively displaying the transfer information in accordance with the results of the comparison.

Typically the transfer information includes:
a) a payload, the payload including the transfer information encrypted using a secret key; and,
b) a header, the header being indicative of the secret key, and wherein method includes, in the tag reader:
   i) determining, from the header, an indication of the secret key;
   ii) obtaining the secret key from a data store using the secret key indication; and,
   iii) decrypting the payload using the secret key.

Typically the tag is an RFID tag, and wherein the method includes, in the tag reader, determining the identifier by:
a) generating a read signal, the tag being responsive to the read signal to modulate the read signal in accordance with the identifier;
b) detecting modulation of the read signal; and,
c) determining the identifier using the detected modulation.

In a second broad form the present invention provides apparatus for tracking a vehicle during a transfer process, the transfer process including one or more stages and utilising a tag having a tag data store, and wherein the apparatus includes a tag reader for:
a) determining an identifier from the tag data store;
b) determining, using the identifier, transfer information at least partially indicative of an identity of the vehicle and a status of the transfer process, wherein the transfer information is used to at least one of:
   i) locate the vehicle;
   ii) confirm that a stage in the transfer is to proceed; and,
   iii) determine the status of the transfer.

In a third broad form the present invention provides a method of tracking a vehicle during a transfer process, the transfer process including one or more stages, the method utilising a tag having a tag data store, the method including:
a) in a processing system:
   i) storing transfer information, the transfer information being at least partially indicative of:
      (1) an identity of the vehicle; and,
      (2) a status of the transfer process;
   ii) associating a tag with the vehicle using an identifier stored in the tag data store; and,
b) providing the tag with the vehicle, such that at one or more selected stages during the transfer process, the tag can be used to determine the transfer information using the identifier from the tag data store, the transfer information being at least one of:
   (1) used to locate the vehicle;
   (2) reviewed so as to confirm that a stage in the transfer is to proceed; and,
   (3) used to determine the status of the transfer.

Typically the identifier is the vehicle identity.

Typically the method includes, in the processing system, associating the tag with the vehicle by recording a mapping between the vehicle identity and the unique identifier.

Typically the method includes, in the processing system, storing the transfer information in at least one of:
a) a remote database; and,
b) the tag data store.

Typically the method includes, in the processing system, causing the identifier to be written to the tag data store.

Typically the tag forms part of an identity card adapted to be coupled to the vehicle, and wherein the method includes, in the processing system, causing the printing of at least the identifier on the identity card.

Typically the vehicle is stored in a storage location, and wherein the method includes, in the processing system, storing location information indicative of a vehicle location within the storage location as part of the transfer information.

Typically the method includes, in the processing system, causing the transfer information to be locked as it is stored or updated.

Typically the method includes, locking the information at least in part by encrypting the information such that the information can only be decrypted using a secret key.

In a fourth broad form the present invention provides apparatus for tracking a vehicle during a transfer process, the transfer process including one or more stages, the method utilising a tag having a tag data store, the apparatus including in a processing system for:
i) storing transfer information, the transfer information being at least partially indicative of:
   (1) an identity of the vehicle; and,
   (2) a status of the transfer process; and,
ii) associating a tag with the vehicle using an identifier stored in the tag data store, the tag being provided with the vehicle, such that at one or more selected stages during the transfer process, the tag can be used to determine the transfer information using the identifier from the tag data store, the transfer information being at least one of:
   (1) used to locate the vehicle;
   (2) reviewed so as to confirm that a stage in the transfer is to proceed; and,
   (3) used to determine the status of the transfer.

Typically the processing system forms part of a tag reader.

In a fifth broad form the present invention provides a method of tracking a vehicle during a transfer process, the transfer process including one or more stages, the method including:
a) associating the vehicle with a tag having an identifier stored in a tag data store;
b) using the tag to:
   i) access transfer information at least partially indicative of:
      (1) an identity of the vehicle; and,
      (2) a status of the transfer process; and,
   ii) track the vehicle through the one or more stages; and,
c) disassociating the vehicle and the tag, thereby allowing the tag to be associated with a subsequent vehicle for transfer.

Typically the method includes, at least one of:
a) associating the tag with a vehicle by recording a mapping between the unique identifier and the transfer information; and,
b) disassociating the tag with a vehicle by deleting a mapping between the unique identifier and the transfer information.

Typically the method includes, performing a stage in the transfer process by:
a) using a tag reader to:
   i) locate the vehicle; and,
   ii) display the transfer information;
b) performing a clearance inspection, at least in part by comparing at least one of the vehicle and the transfer information to clearance criteria; and,
c) in response to a successful clearance, performing at least one of:
   i) updating the transfer information using the tag reader;
   ii) continuing the vehicle transfer process; and,
   iii) returning the vehicle a storage location and updating the transfer information with the new location.

In a sixth broad form the present invention provides a method for use in a vehicle during a transfer process, the transfer process including one or more stages, the method utilising a tag having a tag data store, and wherein the method includes:
a) using a tag reader to:
   i) locate the vehicle; and,
   ii) display the transfer information;
b) performing a clearance inspection, at least in part by comparing at least one of the vehicle and the transfer information to clearance criteria; and,
c) in response to a successful clearance, performing at least one of:
   i) updating the transfer information using the tag reader;
   ii) continuing the vehicle transfer process; and,
   iii) returning the vehicle a storage location and updating the transfer information with the new location.

The methods of any one of the first, third, fifth and sixth broad forms of the invention may be used in conjunctions, and implemented using the apparatus according to the second or fourth broad forms of the invention.

Typically the transfer information is stored as a data packet including:
a) a payload, the payload including the vehicle information encrypted using a secret key; and,
b) a header, the header being indicative of the secret key, and wherein method includes, in the tag reader:
   i) determining, from the header, an indication of the secret key;
   ii) obtaining the secret key from a data store using the secret key indication; and,
   iii) decrypting the payload using the secret key.

In a seventh broad form the present invention provides a method of tracking a vehicle during a transfer process, the transfer process including one or more stages, the method utilising a tag having a tag data store, the method including:
a) determining transfer information indicative of an identity of the vehicle and a status of the transfer process;
b) storing data at least partially indicative of the transfer information in the tag data store;
c) at one or more selected stages during the transfer process, performing at least one of:
   i) reviewing transfer information stored in the store to confirm at least one of:
   ii) that the transfer is to proceed; and,
   iii) the vehicle identity; and,
   iv) updating the transfer information based on one or more events relating to the vehicle transfer.

In an eighth broad form the present invention provides a method of allowing an operator to determine transfer information relating to a vehicle using a tag coupled to the vehicle, the method including, in a tag reader:
a) determining an operator identifier indicative of an identity of the operator;
b) authenticating the operator using the operator identifier; and,
c) in response to a successful authentication;
   i) determining data from the tag data store;
   ii) determining, using the determined data, encoded transfer information;
   iii) determining a secret key;
   iv) decoding the encoded transfer information using the secret key to thereby determine the vehicle information; and,
   v) at least one of:
      (1) presenting the vehicle information to the operator;
      (2) reviewing transfer information;
      (3) updating the transfer information; and,
      (4) comparing the transfer information to predetermined criteria to thereby determine if the transfer is to proceed.

Typically a similar technique may be used to update the transfer information.

In a ninth broad form of the present invention provides a method for allowing an entity to record vehicle information related to a respective vehicle, wherein the vehicle includes first and second tags and where the method includes:
a) storing first encoded data in a first data store of the first tag, the first encoded data being at least partially indicative of manufacturer information; and,
b) storing second encoded data in a second data store of the second tag, the second encoded data being at least partially indicative of owner information.

In a tenth broad form the present invention provides an identity card for use in a vehicle, the identity card including:
a) a visible identifier; and
b) a tag including:
   i) a data store for storing the identifier, the identifier being at least partially indicative of transfer information relating to the vehicle;
   ii) an antenna for receiving a signal from a source;
   iii) a modulator; and,
   iv) a processor for allowing the identifier to be determined using a tag reader.

### BRIEF DESCRIPTION OF THE DRAWINGS

An example of the present invention will now be described with reference to the accompanying drawings, in which:—

FIG. 1 is a schematic diagram of an example of a data tag;

FIG. 2 is a schematic diagram of an example of a tag reader;

FIG. 3 is a schematic perspective view of an the tag reader of FIG. 2;

FIG. 4 is a schematic diagram of an example of a computer system;

FIG. 5 is a flow chart outlining an example of the process of interacting with a tag;

FIG. 6 is a flow chart of an example of the process of registering an operator with a tag reader;

FIG. 7 is a flow chart of an example of the process of writing vehicle information to a tag;

FIG. 8 is a flow chart of an example of the process of reading vehicle information from a tag;

FIG. 9 is a flow chart of an overview of an example of a process for maintaining an audit trail relating to an vehicle;

FIGS. 10A to 10E are a flow chart of the process of exporting a car; and,

FIG. 11 is an example of a card used to associate a tag with the car during a transfer process.

### DETAILED DESCRIPTION OF THE PREFERRED EMBODIMENTS

An example system will now be described with reference to FIGS. 1 to 4, which show a tag, an associated tag reader/writer (hereinafter referred to generically as a “tag reader”) and a computer system that may be used with the tag reader.

FIG. 1 is a schematic diagram of an example of a tag that may be coupled to a vehicle, such as an automobile, truck, car, boat, ship, train, or the like, and which is capable of performing two-way communication with an associated tag reader. In this example the tag 1 includes an antenna 2 coupled to a controller 3, which is typically a microprocessor that provides desired data storage and output functionality. To achieve this, the controller 3 typically includes a processor 4, a memory 5 and a modulator 6 as shown.

In use, the tag receives a signal via the antenna 2, from an associated reader 10, allowing the tag to perform two-way communication with the reader, thereby allowing information stored on the tag to be retrieved and viewed.

In one example tag, known as a passive tag, the controller 3 rectifies the received signal to obtain power, which is supplied to the controller 3, to allow data storage and output to be performed. In a second example, known as an active tag, the tag includes a power supply, such as a battery 7, which is used to power the controller 3. In general, as active tags do not need to obtain power by rectification of a received signal, they have a greater range than passive tags, but conversely typically have a lifespan that is limited to the life of the battery. In this instance, the active tags may implement memory with a smaller memory capacity to thereby minimise the amount of information that is transferred from the tag to the reader, which in turn increases battery life. In this instance, it may therefore be typical to store only a unique identifier in the tag memory, which is then used to cross reference the remote database allowing relevant information to be viewed. In this instance, whilst any unique identifier may be used, to avoid identifier duplication, a unique identifier based on registration information, such as the vehicle VIN can be used.

The tag 1 may be used to store vehicle information related to a respective vehicle. This may be achieved either by storing a unique identifier that can be used to cross reference a remote database containing vehicle information relating to the vehicle, or can alternatively be used to store the vehicle information directly on the tag itself, depending on the preferred implementation. The vehicle information can include for example at least one of:
Manufacturer information which may include:
   Vehicle Make;
   Vehicle Model;
   Year of Manufacture;
   Manufacturer identity;
   Country of Manufacture;
   Engine/Chassis number;
   Vehicle part numbers;
   Odometer reading;
   VIN (Vehicle Identification number);
   Transmission number;
   Steering rack number;
   Differential number;
Owner information which may include:
   Owner's name;
   Owner's address;
   Owner's license number;
Registration details;
Inspection details;
Servicing details;
Insurance details; and,
Contact details of main driver of the vehicle.

It will be appreciated that the vehicle information stored and retrieved on the tag will have various applications, as will be described in more detail below.

The tag 1 may be coupled to a vehicle using various methods. For example the tag may be attached directly the vehicle frame or chassis, be inserted into a chamber of a frame included in the vehicle, such as a neck of a bicycle seat. Other methods of coupling the tag to the vehicle may include incorporating the tag in the form of a plate which is coupled to the engine or other suitable parts of the vehicle, or in the form of an identity card that can be attached to a suitable part of the vehicle, as will be described in more detail below.

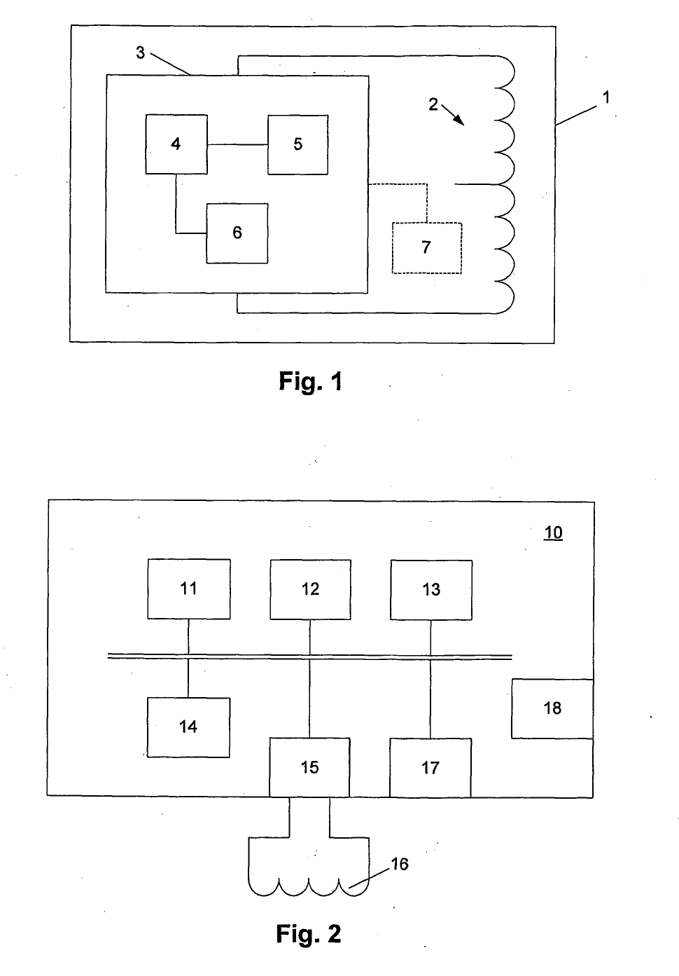

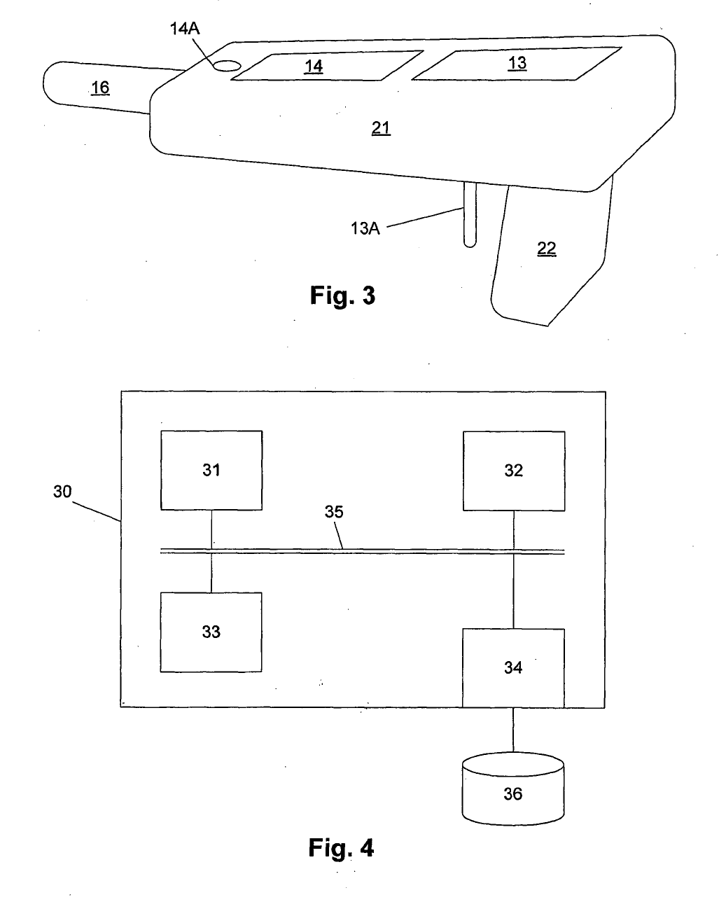

An example of a reader is shown in FIGS. 2 and 3. In particular, the reader 10 includes a processor 11 coupled to a memory 12, an input device 13, a display 14, a modulator 15 and an external interface 17 via a bus 18 as shown. The modulator 15 is coupled to an antenna 16.

In use, the modulators 6, 15, and the associated antennas 16, 2, when positioned in close proximity, form an inductively coupled tuned circuit. Accordingly, passing an alternating current through the antenna 16 causes a corresponding current to be induced in the antenna 2. In use, the modulators 6, 15 can be used to alter the inductance, and hence the resonant frequency of the tuned circuit. This in turn allows information to be transferred between the tag 1 and the reader 10.

Thus, generation of a suitably modulated signal by the modulator 15 can be detected by the modulator 6, allowing data to be written to the tag 1. In this case, the processor 4 interprets the modulated signal, and writes the received data into the memory 5. Conversely, the modulator 6 can be used to modulate the signal induced in the antenna 2, thereby causing backscatter modulation of the signal generated by the modulator 15, which can be detected by the modulator 15, allowing data to be read from the tag 1.

It will be appreciated by persons skilled in the art that in one example this is therefore an RFID type tag system. In this case, modulation of the signals can be either phase or amplitude modulation, with the coupling between the tag and the reader being either inductive (as described above) or capacitive, depending on the preferred implementation.

An example of the external configuration of the reader 10 is shown in FIG. 3. As shown, the reader 10 includes a housing 20 having a main portion 21 coupled to a handle 22. The housing typically includes the display 14, optional additional display indicators 14A, and the input device 13, typically in the form of a keypad entry system 13, or the like, mounted thereon. Additional input control such as trigger 13A may also be used as shown.

In one example, the antenna 16 is in the form of a telescopic antenna as shown in FIG. 3. Alternatively the antenna may be contained provided within the main housing 21 depending on the intended use, as will be described in more detail below.

Typically the reader 10 is also adapted to communicate via the external interface 17 with a computer system, shown generally at 30 in FIG. 4. Typically the computer system includes a microprocessor 31 coupled to a memory 32, an input/output device 33, such a keyboard and display or the like, and an external interface 34, coupled together via a bus 35 as shown. The computer system 30 may be coupled to a remote database 36, via the external interface 34, as shown.

Additionally, or alternatively, the external interface 34 may be coupled to the external interface 17 of the reader 10, such as through the use of an RS232 serial connection, USB connection, wireless Bluetooth connection, or the like. In use the processors 11, 31 execute application software that allows the reader 10 and the computer system 30 to communicate and transfer data therebetween as required. Additional functionality may also be provided as will be described in more detail below.

It will therefore be appreciated that the computer system 30 may be any form of a computer system such as a desktop computer, lap-top, palm-top, specialised hardware or the like. Similarly, the processor 11 utilised by the reader 10 can be implemented in a variety of forms and may be formed from a Programmable Logic Array (PLA), specialised hardware or the like.

In use, the system allows vehicle information to be stored and subsequently retrieved using the reader 10 alone, or using a combination of the reader 10 and the computer system 30.

In one example of the invention, the tag 1 is a tag having a high data storage capacity, such as a 125 kHz Hitag S 2048 RFID tag. This allows a significant amount information, and in particular, up to 1920 bits or 240 characters, to be stored directly on the tag, without necessarily requiring access to a remote database.

In such a system, as tags may be read remotely and using any appropriate reader, there is the potential for any information stored on the tag to be accessed by third parties. As in many applications to the tag will contain confidential information such as user details, this is undesirable. Accordingly, in order to ensure that privacy of the information is maintained, the system typically utilises a strong encryption technique so that the information is stored on the tag 1 in an encrypted format. This, coupled with controlled dissemination of the secret keys, ensures the information remains secure.

However, in an alternative example in which the data capacity of the tag is smaller, such as if an active tag is used, then it is typical for the tag to store only a unique reference number or other identifier. This is used to access a remote secondary database storing the vehicle information. In this instance, the reference number stored on the tag is mapped to a database entry for the respective vehicle, for the time the tag is associated with the vehicle, as will be described in more detail below. In this instance, the reference number on the tag is typically locked to prevent alteration. Furthermore, as the database can contain confidential information, it is also typical for the information in the remote database to be locked to prevent alteration and unauthorised access. This can be performed in a manner similar to the encryption of data on a high capacity tag, as will be described in more detail below.

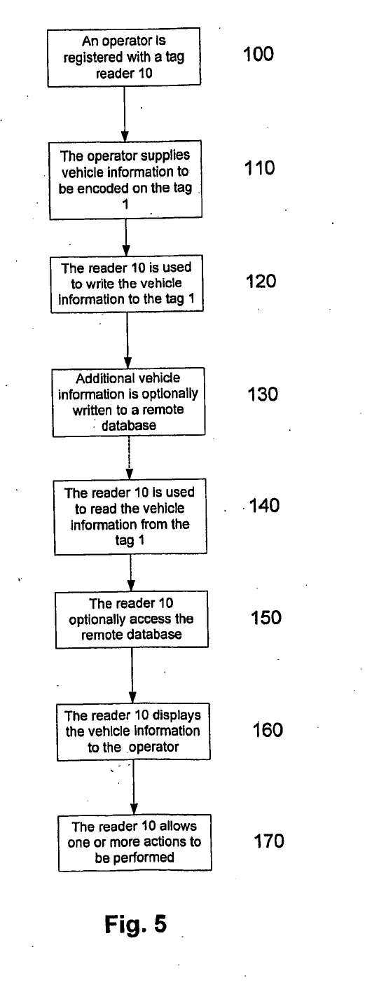

An example of use of the system will now be described with reference to FIG. 5.

At step 100 an operator undergoes a registration procedure, which associates the operator with one or more respective tag readers 10. This creates a unique association between the operator and the reader(s) 10, so that only validly registered operators may use the readers 10. This may be a one off procedure, and is not necessarily required each time information is to be written to a tag.

At step 110 vehicle information is provided either to the reader 10, via the computer system 30 or the input device 13, or directly to the computer system 30, allowing the vehicle information to be stored. In the case of a passive tag, the vehicle information is stored on the tag. However, in this example, the vehicle information is stored in a remote database at step 120, and associated with an identifier stored on the tag at step 130. This is typically achieved by using the reader 10 to determine the identifier, and then store this with the vehicle information in the database.

These steps, which represent the writing procedure, may be performed by any one of a number of entities depending on the circumstances in which the process is used. For example, if the tag is used to track a vehicle during an export process parties taking part in the export procedure may all need to write information to the tag. Alternatively, if the tag is to track events relating to a vehicle during its life from manufacture, parties may include the manufacturer, as well as any mechanics performing work on the vehicle, registration authorities, or the like.

Once the writing procedure is complete, the information can be read from the tag using the reading process outlined in steps 140 onwards.

In particular, at step 140 a reader 10 reads the identifier from the tag 1, and uses this to access the remote database 36 at step 150. This allows the reader 10, or the computer system 30 to display the vehicle information to the operator at step 160. One or more actions associated with the provided information may then be performed at step 170.

It will be appreciated that the process may be performed other entirely by the reader 10, or partly by the reader 10 in conjunction with the computer system 30. Thus, for example, information to be written to the tag may be input into the computer system 30 and then subsequently uploaded to the reader 10. This may be used if the computer system 30 has a more user friendly input interface that allows for easier entry of the data. For clarity the following description will focus on the process being performed by the reader 10, although it will be appreciated that all of the processes may be performed by the reader 10 in conjunction with the computer system 30, depending on the preferred implementation.

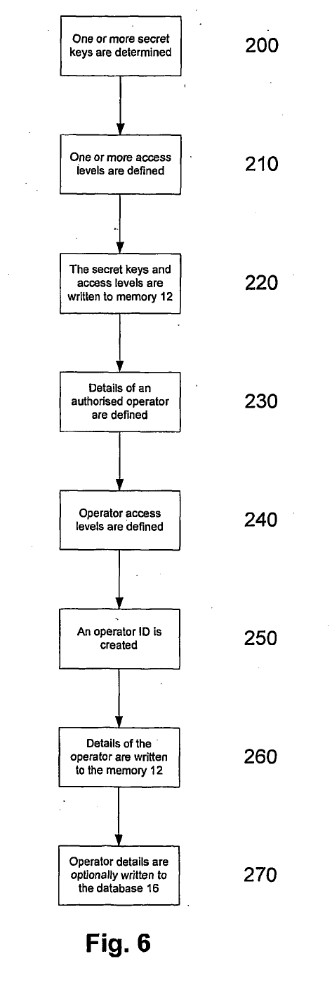

An example of a procedure in which vehicle information is encrypted will now be described in more detail with respect to FIGS. 6, 7 and 8. In this example, the operator is registered with a reader to reduce availability of access to the vehicle information. The procedure for registering an operator to use the reader is set out in FIG. 6.

In this example, the process is generally separated into a reader initialization phase at steps 200 to 220, and an operator registration at steps 230 to 270. During the reader initialization phase, as shown at step 200, one or more secret keys are generated, with the secret keys being used for encrypting specific types of information.

The secret keys can be shared amongst a number of readers to allow a number of readers to access the data provided on a tag 1, in which case the keys may be obtained from a database or the like. Alternatively, the secret key may be new, for example if it is unique to respective reader 10, or if it is the first time a respective type of information is to be used, in which case the key may be generated using a predetermined algorithm. Whilst any form of secret key encryption system may be used, in one example the system uses a 128 bit AES encryption protocol and based on a 64 bit secret key.

At step 210 it is possible to define one or more access levels. These represent an access right associated with information that is to be provided to the tags, thereby allowing access to information to be selectively restricted so that different operators may be assigned different access rights. At step 220 the keys and details of the access levels are stored in the memory 12 of the reader 10 using conventional techniques.

Steps 200 and 220 may only need to be defined the first time the reader 10 is used. Alternatively, depending on the respective circumstances these may be repeated as often as required.

At step 230 operator details are defined associated with one or more operators of the reader 10. The operator details may include a range of information such as the operator's name and other personal information, details of employment, employers, or the like. Access levels associated with the operator are then defined at step 240. Thus, if a number of operators are associated with the reader 10 is may be desirable that some information stored on the tag 1 is only viewable by certain operators, in which case those operators may be provided with a different access level. Access levels may also be used to control writing of information to tags 1, depending on the circumstances in which the situation is used.

At step 250 an operator ID is created to allow the operator to be authenticated by the reader 10. The nature of the ID will depend on the authentication mechanism used and will be discussed in more detail below.

At step 260, details of the operator including at least the operator ID and any access levels associated with the operator are stored in the memory 12 of the reader 10. Further details may also be stored in the remote database 36 to allow these to be accessed or updated independently of the reader 10. As an alternative to the procedure described above, the operator details may be stored solely in the database 36, in which case when authentication of the operator is performed, then this requires the reader 10 to access the remote database 36.

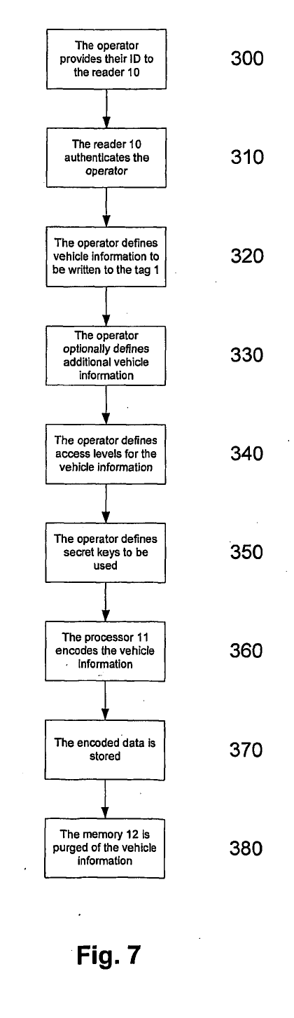

Following this procedure, the operator is then able to use the respective reader 10 for tag reading/writing operations, as will now be described with reference to FIGS. 7A and 7B.

At step 300 the operator supplies their ID to the reader 10. The manner in which the ID is supplied will depend on the authentication mechanism used as discussed in more detail below. At step 310 the reader 10 will operate to authenticate the operator by comparing the received ID to the operator ID stored in the memory 12 at step 260. If the reader 10 is connected to an internal computer system, such as a LAN, or the like, when the operator logs onto a computer on the LAN, this can be used to automatically authenticate the operator with the reader 10. Alternatively, the operator's computer system 30 may be required to forward authentication credentials to the reader when the reader 10 is used.

If the operator is authenticated the process proceeds' to step 320, allowing the operator to define vehicle information to be stored on the tag. The information may be entered via the input 13 or alternatively via the computer system 30, which then transfers the vehicle information to the reader 10 via the external interface 17. The operator may also define additional optional vehicle information for storage in a remote database at step 330.

At step 340 the operator defines one or more access levels associated with the vehicle information. A single access level may be defined for all of the information, or alternatively, different portions of the information may be associated with different access levels, depending on the information's sensitivity. For example, the vehicle information may include manufacturer information and/or owner information as discussed above. In certain situations, it may be appropriate that a particular operator may only be able to read the manufacturer information, whilst another operator which may be able to read and write both owner and manufacturer information. Various levels of authorization such as access flags may be used to indicate the access of data for particular operators, as will be described in more detail below.

Thus, the access levels may vary for different portions of the information and it will therefore be appreciated that this can be achieved by defining different classes of vehicle information with a different access level being defined for each respective class.

In order to ease entry of the information, it is typical for the user to be presented with a GUI (graphical user interface), on the computer system 30 or the reader 10, which includes fields into which the information may be entered. The respective fields presented may depend on the type of information provided. In any event, this can allow the user to associate different access levels with the different fields, thereby easily designating the access levels.

At step 350 the reader 10 is used to select a secret key associated with the vehicle information. This may be selected automatically by applications software executed by the processor 11, for example depending on the type of information entered, or may alternatively be selected by the operator. In addition to this, it will be appreciated that the key may be a predetermined key, or alternatively may be generated in-situ utilising an appropriate algorithm. It will be appreciated that the information may also be encrypted using multiple secret keys, including for example providing a respective secret key for each access level. Thus, for example, the vehicle information may include manufacturer information and owner information, and therefore a separate secret key set being used for each type of information to provide additional security.

At step 360 the processor 11 operates to encode the data using the one or more secret keys. The processor 11 achieves this by generating a binary string representing the vehicle information to be stored, together with details of the associated access levels. This may be in the form of a character string, using associated flags to define the access level. The resulting string is then encrypted using the selected secret key, to generate an encrypted string, which is then associated with a header indicative of the secret keys used to encrypt data. The encrypted string will hereinafter be referred to as a payload, with the combined payload and header forming a data packet.

At step 370 the data packet is stored. In the case of passive tags, the data packet is written to the tag, whereas for active tags the data packet is stored in the remote database, before being associated with an identifier stored on the tag 1, as described above. The vehicle information is typically locked using a WORM (write once, read many) process, so that the data cannot be subsequently altered, although this is not essential. An example of information that may be used in a WORM process includes manufacturer data, as this information remains constant over the vehicle's life, and as such should not require editing. However, in contrast, owner information may change over the vehicle's lifetime and as such this information would not be appropriate to be stored in a WORM format.

It will be appreciated by persons skilled in the art that even though although the vehicle information is locked, this does not prevent additional information to be associated with the tag at a later date, for example allowing a change of ownership or the like to be recorded.

At step 390 the contents of the memory 12 in the reader 10 and additionally the contents of the memory 32 and the computer system 30 are purged to thereby ensure the vehicle information is not retained on the device. This helps further ensure the confidentiality of the information.

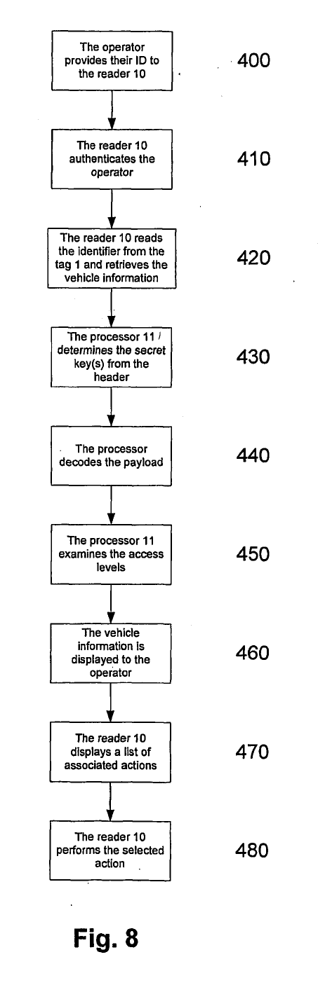

The manner in which information is read from the tag will now be described with reference to FIG. 8.

At step 400 the operator supplies their ID to the reader 10, thereby allowing the reader 10 to authenticate the operator at step 410. At step 420 the operator activates the reader 10, for example using the trigger 13A, thereby causing the reader 10 to determine the identifier from the tag 1, and then access the vehicle information from the remote database. This may be achieved for example, via a wireless network, such as the mobile phone, GPRS network, or the like, and display the additional information to the operator. Alternatively, if the database 36 cannot be accessed, then this may be indicated to the operator on the display 14, allowing the vehicle information to be retrieved at a later opportunity.

Once the vehicle information is retrieved, the processor 11 operates to read the data packet header at step 430, and determine the one or more secret keys used in encrypting the payload, thereby allowing the processor 11 to decrypt the payload using the secret keys at step 440.

The processor 11 parses the decrypted data to determine any access levels associated with the vehicle information provided therein, at step 450. This allows the processor 11 to compare the access level of the operator with the access level of the vehicle information and assess whether the operator is authorised to view some, or all, of the vehicle information. This vehicle information is then presented to the operator at step 460, using the display 14. Alternatively, or additionally, the information may be displayed on the computer system 30.

In addition to displaying the vehicle information, the reader 10 may be adapted to allow one or more actions to be taken relating to the vehicle information. Whilst this does not generally include alteration of the vehicle information stored on the tag 1, this could include using the vehicle information for certain purposes, as will be described in more detail below.

In this case, the processor 11 will determine a list of actions associated with the vehicle information or other available actions depending on the implementation and display these to the operator at step 470. This is typically achieved by having the processor 11 execute applications software, which is stored in the memory 12, and which is specific to the respective use of the reader 10, as will be appreciated by a person skilled in the art. This allows the operator to select one of the actions, with this being at least partially performed by the reader 10, or the computer system 30, at step 480, in accordance with instructions defined in the applications software.

### Audit Trail

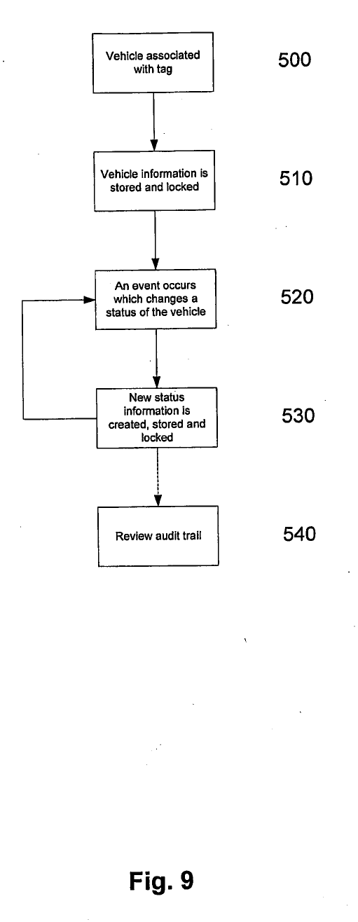

An example of an audit trail process will now be described with reference to FIG. 9.

At step 500, a vehicle is associated with a tag, with corresponding vehicle information is being stored in the remote database or on the tag, and locked, at step 510. This can occur at any suitable time, such as for example, when a manufacturer creates the vehicle, and typically involves associating an identifier stored on the tag with an vehicle information entry created in a suitable database.

At step 520, an event occurs changing the status of the article, and accordingly new status information is generated reflecting this change. The new status information may then be stored together with, or as part of the vehicle information, at step 530. This may includes details such as a transfer of the ownership of the vehicle, any repair work performed, details of servicing, vehicle roadworthiness tests performed, clearance test results, or the like. When further events occur, steps 520 and 530 are repeated for the particular event.

Consequently, at step 540, the vehicle information and the associated status information can optionally be reviewed. As the status information is locked when it is stored, for example using the encryption and/or WORM processes described above, this allows the status information to provide an audit trail of events that have occurred for the respective vehicle. This allows the history of individual vehicle to be subsequently retrieved and reviewed.

Thus for example if a reseller is purchasing a vehicle for sale, it will be typical for the reseller to perform a check of the vehicle information prior to completing the purchase. This is performed to ensure that the vehicle is a genuine vehicle, or has been genuinely manufactured by an indicated entity, has been correctly serviced, etc. This can be used to ensure that the vehicle is not fraudulent or that the vehicle meets certain required safety standards.

Similarly, in a vehicle transfer process, this allows details of the vehicle to be checked, for example, to compare these to clearance requirements to ensure that these are satisfied, or to determine the status of a transfer process.

It will be appreciated that in the above-described process, the read/write operations may be performed as outlined above with respect to FIGS. 6 to 8. Furthermore, whilst the audit process has been described with respect to vehicles, this may be applied to other articles. Thus, the vehicle information may be article information, in which case the nature of the stored information will depend on the circumstances in which the process is used and the article in question.

### Vehicle Tracking

Vehicle transfer processes mentioned above, such as vehicle export/import procedures, typically involve a number of stages, during which time the vehicle is examined to determine if it satisfies government requirements or the like. This can include for example, ensuring the vehicle satisfies road worthiness requirements, that it is uncontaminated to satisfy quarantine restrictions or the like. During the transfer process, it is also typical to need to track the vehicle, for example to allow the vehicle to be located in shipping yards, to ensure the vehicle successfully reaches its destination, and to ensure tampering with the vehicle does not occur.

The tracking can be achieved using the tags described above. In one example, this is achieved by associating an identifier encoded on the tag with transfer information that is indicative of the vehicle identity and a status of the transfer process. This allows a reader to be used to determine the identifier and then access the transfer information. By encoding suitable information within the transfer information, this allows the reader 10 to be used in locating the vehicle, confirming that a stage in the transfer is to proceed or determining the status of the transfer.

Thus, for example, the transfer information can include the vehicle information outlined above, allowing various attributes of the vehicle to be determined. These can then be compared to clearance requirements to determine if the vehicle transfer should proceed. Similarly, location information can be stored, allowing the vehicle to be located in the shipping yards.

It will be appreciated that the identifier may form part of the transfer information so that the transfer information is stored on the tag in its entirety, should there be sufficient data capacity on the tag. The process of storing, reviewing and amending transfer information can also be performed using the techniques outlined above, and accordingly, this can use an audit trial type arrangement to track the vehicle during the transfer process.

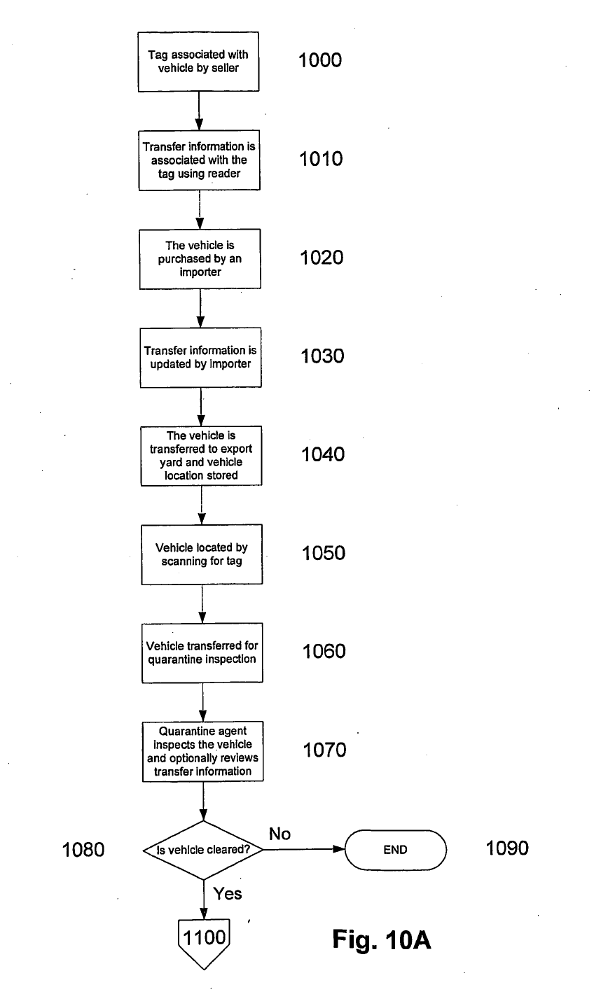

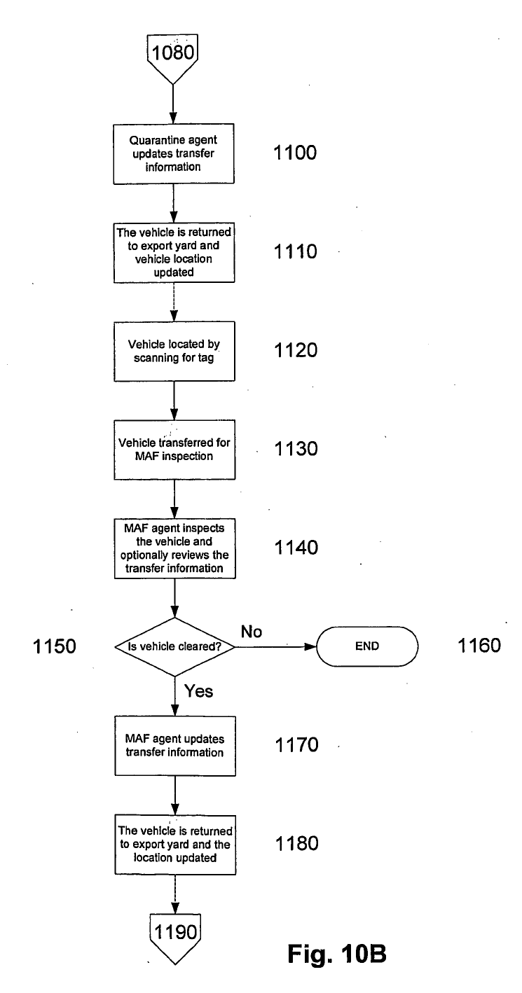

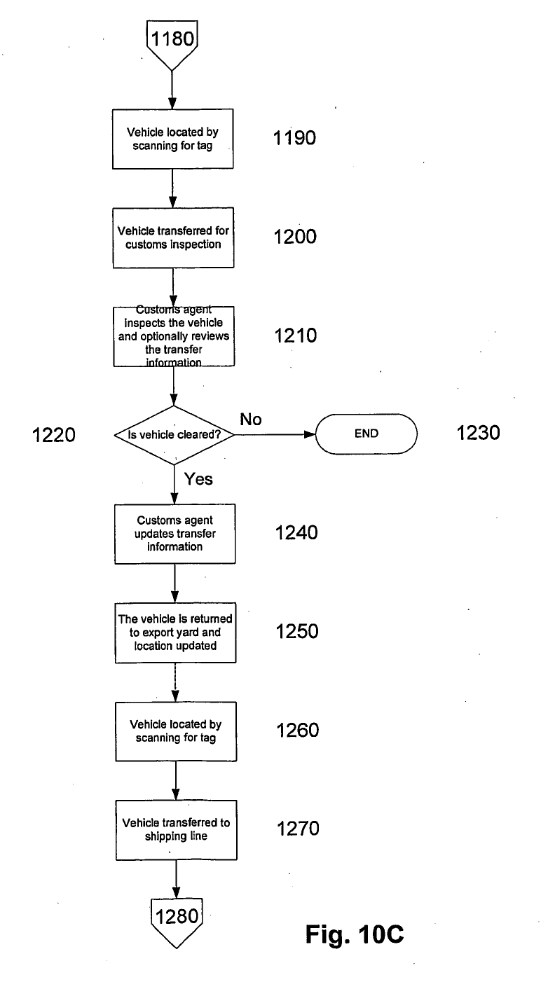

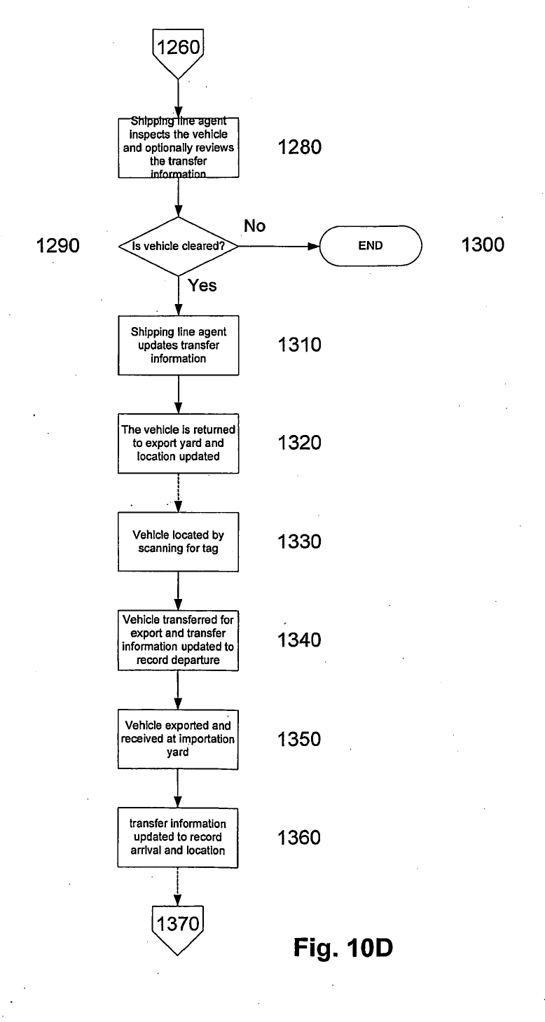

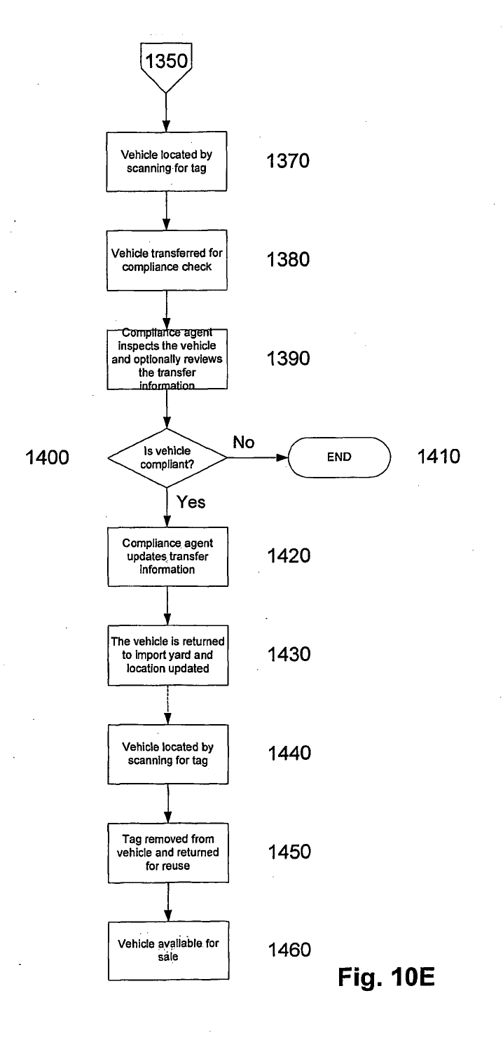

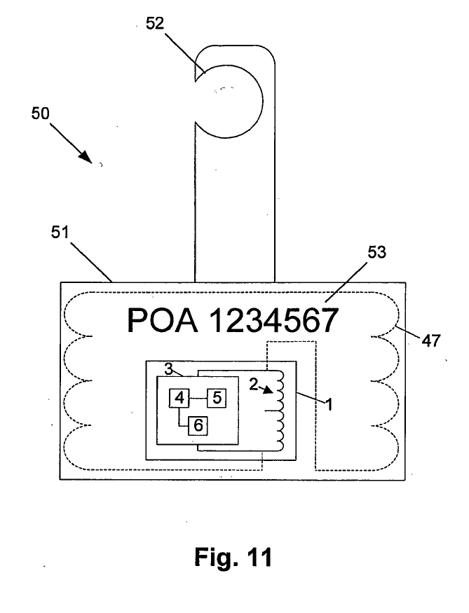

A specific example of the process when used for importing a vehicle will now be described with respect to FIGS. 10A to 10E, and FIG. 11.

At step 1000 at least one tag is associated with a vehicle by a seller. In this regard, if the vehicle is a new vehicle the seller may be the manufacturer selling the vehicle onto an export company or the like. Alternatively, in the case of a second-hand vehicle the seller may be a sales company or the like.

The manner in which the tag is associated with the vehicle will vary depending on the preferred implementation. In one example this is achieved using an attachable identity card an example of which is shown in FIG. 11. As shown the identity card 50 includes a body 51 and a hook 52, which allows the identity card to be attached to a vehicle, for example by hanging from the vehicle's rear-view mirror. The identity card 50 typically includes a unique reference number, shown generally at 53, as will be described in more detail below.

Additionally, or alternatively, the tag can be fixed directly to the vehicle. For example, the tag could be mounted on the vehicle chassis, or the like and in one example, two tags may be utilised with a first tag attached to the vehicle and the second tag provided on a identity card similar to that shown in FIG. 11.

At step 1010 the seller provides transfer information, which is associated with the tag. Thus, for example, if the tag is an active tag and the transfer information is stored in the remote database 36, the tag will be associated with the transfer information by mapping the database entry to the unique identifier, which in this case may be the reference number 53, or based on transfer information such as the vehicles VIN.

This may be performed by the tag reader 10, although typically the processing system 30 may be used if interaction with the tag is not required, for example, if the reference number 53 is known. Alternatively, the tag reader 10 can be used to enter the transfer information and then associate this with the reference number 53 upon reading of the tag, which is already provided in the vehicle. This helps ensure that the correct tag is provided with the corresponding vehicle.

The transfer information provided will depend on the information available and in either case will typically be locked through the use of suitable encryption mechanisms as described above. Initially, the transfer information will include at least vehicle information such as:
manufacturer's identity;
vehicle make/model;
year/date of manufacture;
year/date of first registration;
engine capacity;
vehicle colour;
manufacture location;
vehicle type (e.g. 2 door saloon);
odometer reading;
VIN (Vehicle Identification Number);
chassis number;
engine number;
year of build;
transmission number;
steering rack number;
differential number; and,
any other related information.

Additionally, the transfer information may include an indication of the current status of the transfer process, and optionally future stages in the transfer process that must occur.

At step 1020 the vehicle is purchased by an importer, typically from an auction, car yard, or the like, who then typically updates the transfer information at step 1030 to include information relating the purchase, such as:
date of purchase;
identity of the purchaser/exporter;
intended destination; and
any other relevant information.

The status of the vehicle transfer can also be updated.

The vehicle is then transferred to an export yard at step 1040, where it will undergo a number of checking procedures prior to export. During this process the vehicle location will be stored as part of the transfer information. Thus, for example, the transfer information will typically be updated to include an indication of a general area within the export yard where the vehicle is located. The location may be in the form of a specific bay number but more typically is limited only to a region of the yard as will be discussed in more detail below.

At step 1050 the vehicle is subsequently located by scanning for the tag. In this instance, when a region is indicated, an individual locating the vehicle can access the remote database 36, for example, using the computer system 30, to determine the region in which the vehicle is located. The individual can then use the reader 10 to access the tag and hence locate the vehicle.

To achieve this the reader 10 can be configured with a mechanism that allows the operating range to be adjusted. The operator provides an indication of the vehicle to be located, for example, by providing an indication of the reference number 53, or the vehicle VIN, which is then used to determine the reference number 53. The reader 10 then interrogates any tags within the current operating range, providing an indication if one of the tags matches the reference number 53.

If the relevant tag, and hence vehicle is not located at the current operating range, the operator increases the range, to widen the search until the vehicle is located. Once the tag is located, this allows the operator to determine a general vicinity for the vehicle based on the operating range. The operator can then identify the vehicle by visual inspection of the identity card 50.

At step 1060 through to 1320, the vehicle typically undergoes a number of inspection stages to clear the vehicle for export. This may include inspection by one or more government agencies, depending on the type of vehicle and where the vehicle is being exported to/from. It will therefore be appreciated that the following example is for the purpose of illustration only, and the specific inspections performed will depend on the exact export process used.

In this example, at step 1060 the vehicle is transferred for quarantine inspection with the quarantine agent inspecting the vehicle and optionally reviewing transfer information at step 1070. This can be achieved for example by having the reader 10 determine reference number 53 from the tag, access the corresponding transfer information in the database 36, and then display the transfer information to the operator on the display.

This can be performed using the procedures outlined above so that the reader authenticates the quarantine agent before providing access to the transfer information. The quarantine agent will typically use the transfer information to ensure that the transfer information is correct in relation to the respective vehicle, and to check whether any action, such as a specific cleaning is required. At least some of this process may be performed automatically by the reader 10 or processing system 30, by comparing the transfer information to predetermined criteria, to determine if any clearance requirements are not met, although at least some manual inspection of the vehicle is typically required.

At step 1080 the quarantine agent accesses whether the vehicle should be cleared and if not the procedure ends at step 1090. In this instance, if failure occurs for a particular reason the vehicle may be returned for further processing, such as to overcome the reasons for clearance failure with the steps 1060, 1070 then being repeated.

Once the vehicle is cleared, the quarantine agent updates the transfer information to reflect the new transfer status, including details of the clearance at step 1100, before returning the vehicle to the export yard with the vehicle location being updated at step 1110 at described above. The updated information may include details such as:
clearance number;
agent identity (e.g. name);
inspection date;
inspection number;
clearance restrictions;
intended destination;
details of required modifications; and,
any other relevant information.

At step 1120 the vehicle is located by scanning for the tag as described above, with the vehicle then being transferred for MAF (Ministry of Agriculture and Fisheries) inspection at step 1130. At step 1140 the MAF agent inspects the vehicle and optionally reviews transfer information to determine if the vehicle should be cleared. If the vehicle is not cleared at step 1150 the process moves on to step 1160 and ends or alternatively allows the vehicle to be sent for treatment until clearance requirements are met. Otherwise at step 1170 the MAF agent updates the transfer information, with similar clearance information to that described above with respect to quarantine, with the vehicle being returned to the export yard and the location updated at step 1180.

At step 1190 the vehicle is located by scanning for the tag with the vehicle being transferred for customs inspection at step 1200. The customs agent inspects the vehicle and optionally reviews transfer information using this to determine if the vehicle is cleared at step 1220. Again, at least some of this can be performed automatically by comparison of the transfer information to predetermined clearance requirements. For example, if a vehicle is manufactured in the United States of America with left-handed steering and the vehicle is being imported to Australia where a right-handed steering legislative requirement exists, this would be defined by the inspector as a clearance requirement, which would need to be satisfied before the vehicle could be used or sold in Australia.

If clearance is not provided at first instance, the process moves to step 1230 with the process either ending or the vehicle being treated or otherwise modified in order to overcome the customs clearance requirements.

At step 1240, once customs is cleared, the customs agent updates the transfer information with the vehicle being returned to the export yard with the location updated at step 1250. The customs clearance information typically includes information such as:
a customs clearance number;
a quarantine number;
a customs agent identity;
date of customs inspection; and
any other related information.

At step 1260 the vehicle is located by scanning for the tag with the vehicle being transferred to the shipping line at step 1270. At step 1280 the shipping agent inspects the vehicle and reviews the transfer information. At step 1280 the shipping line agent determines if the vehicle is clear for transfer with the process ending at step 1290 if the vehicle cannot be transferred. Thus, for example, the agent can check the transfer information associated with the tag and compare this to actual vehicle to ensure that the vehicle is the correct vehicle and that the vehicle has net been tampered with, or the like.

Otherwise at step 1310 the shipping line agent updates the transfer information with the vehicle being transferred to the export yard and location updated at step 1320.

At this point the shipping agent typically associates shipping information with the transfer information including information such as:
identity of shipping company;
identity of shipping agent;
date of loading;
date of shipping;
date of departure;
intended destination;
date of intended arrival;
shipping requirements;
details for contact in case of mishap;
freight number;
customs clearance number; and
any other related shipping information.

At step 1330 the vehicle is located by scanning for the tag before being transferred for export with the transfer information being updated to record the departure. At this stage, and typically as the vehicle is loaded onto the ship for transport, the transfer information is checked to ensure that the vehicle has undergone the necessary clearance requirements, and to ensure that the vehicle is loaded onto the correct ship.

To achieve this, reader 10 can be provided near the loading ramp to the ship to scan each vehicle as it is loaded. In this instance, the reader 10 can be adapted to determine the reference number from the tag and access the vehicle details stored in the database. The shipping information is then extracted from the transfer information and compared to the current loading schedule. In the event that the vehicle is being incorrectly loaded onto the ship, then an alarm can be sounded, thereby ensuring that the vehicles are correctly loaded.

At step 1350 the vehicle is exported and received at an importation yard. The transfer information is updated to record the arrival and the vehicle's location in the yard at step 1360.

At step 1370 the vehicle is located by scanning for the tag with the vehicle being transferred for compliance checking at step 1380. At step 1390 the compliance agent inspects the vehicle and optionally reviews the transfer information to determine if compliance requirements are satisfied at step 1400.

If compliance requirements are not met, the process can either end at step 1410 with the vehicle typically being transferred for destruction or return, or alternatively, the vehicle can be modified to overcome any necessary requirements.

Thus, for example, if the tyres on the vehicle are unsatisfactory, the importer arranges for a mechanic to supply and fit appropriate tyre to the respective vehicle. At this stage, modification information, reflecting the modification made to the car can also be written to the tag 1, once the appropriate modification has been performed satisfactorily. The modification information typically is written to the tag by an entity that performed the modification. Therefore, the entity would need to be authenticated by the reader so as to allow the modification information to be written to the tag. It will be appreciated that the modification information may include information such as:
mechanic identity;
modification date;
modification reference number;
a list of modifications made; and,

At step 1420 the compliance agent updates the transfer information with the vehicle being returned to the import yard and location updated at step 1430. At step 1440 the vehicle is located by scanning for the tag before the tag is removed from the vehicle and returned for reuse. Thus, in this example the identity card 50 will be removed from the vehicle and returned to a seller or other entity for reuse, before the car is made available for sale at step 1460.

In the above example, the transfer information is associated with the identity card through the use of the reference number. As the identity card 50 and hence reference number are typically reused, the vehicle and reference number are typically dissociated by removing the reference number from the database entry.

Whilst the transfer information can be discarded, in general it is preferable to retain the transfer information, and at least the vehicle information, as it contains a large volume of data relating to the history of the car import process and can therefore act as an audit trail. Thus, for example, if it becomes apparent that the car is in someway defective, this allows the transfer information to be used to review movements of and actions taken with the vehicle, which may allow a determination of whom is responsible for the faults.

In order to ensure that the audit trail is useful, it is preferable that the transfer information is locked each time it is updated to prevent its subsequent alteration. In this regard, once information has been locked it cannot be removed or amended, but additional information can be added, thereby providing an audit trail as outlined above. As a further back-up, to prevent subsequent alteration of the tag, information may be additionally stored on a further remote database, cross referenced to the car based on the VIN number.

The transfer information can be retained in any one of a number of manners. For example, if another tag is attached to the vehicle, this will be retained and the information thereon updated as required. Alternatively a new tag could be added if required, or the information merely stored in the database, or transferred to an alternative database, for subsequent reference. In this instance, as the reference number is removed from the database record, to allow the identity card to be reused, the transfer information is typically accessed using an alternative identifier such as the VIN.

In the event that a further tag is provided on the vehicle, the tag 1 may be coupled to the car using any one of a number of techniques. In one example, particularly if the tag 1 is used for secure vehicle tracking, it is preferable that the tag should not be easily removable, thereby preventing tampering, for example, by tag substitution. The tag should also be relatively accessible to that extent required to ensure successful reading/writing of data. Thus, it is important to ensure that the tag is not mounted in a position which results in the tag being shielded by the car.

In general, the tag may be mounted in any one of the following locations:
on or in the chassis;
on the firewall;
as part of the VIN plate;
within the bonnet or boot lid;
any other suitable location.

Typically tag is fixed to the vehicle such that it may not be removed, and this may include for example, riveting the tag to the car body using a mounting plate, such as the VIN plate. Alternatively, the tag may be embedded in material which is transmissive to RF signals of the frequency used to read data from or write data to the tag. This can include for example embedding the tag in a suitable polymer, or the like, to thereby prevent tampering with the tag.

In the event that the transfer information is updated when the vehicle is sold, this can include purchaser details, such as:
insurance company details including:
policy numbers;
insurance provider identity;
expiry date;
finance company details including:
policy numbers;
finance company identity;
expiry date;
owner details including:
name;
address; next of kin;
intended or normal parking location; and,
any other related information.

It will be appreciated that following this, any changes in registration details and vehicle ownership may also be written to the tag 1 as required in a similar manner. Additionally a registration sticker may be provided including an additional tag, which is used specifically to encode registration information that would typically change on an annual basis, as described in copending application number PCT/AU2005/001560.

The registration information can include:
the registration number;
license plate number;
manufacturer's identity;
vehicle make/model;
year/date of manufacture;
year/date of first registration;
engine capacity;
vehicle colour;
manufacture location;
vehicle type (e.g. 2 door saloon);
odometer reading;
VIN (Vehicle Identification Number);
chassis number;
engine number;
year of build;
transmission number;
steering rack number;
differential number; and,
car colour;
odometer reading;
a valuation;
dealer identity;
vehicle source;

A vehicle may also be provided with two tags, with certain information, such as the VIN number may be stored on both tags for cross reference purposes. This allows an independent check to be performed to ensure that neither tampering has not occurred. In the event that two tags are provided. In this case, each tag may be adapted to store respective types of information. Thus, for example, one of the tags may be used for the purpose of storing information relating to the manufacture of the vehicle, with the other tag providing an audit trail of ownership, or the like. However, it will be appreciated that this is not essential and will depend on the respective implementation.

It will be appreciated by persons skilled in the art that the above described importation process can also be modified for use in other circumstances, and in particular to any vehicle transfer or sale. Thus, whilst the example is specific to car importing, the process can be modified to provide an audit trail of any post manufacture events relating to the car.

Furthermore, whilst the above described process has been described with respect to usage of the tag 1 and reader 10, and the associated methodologies described above in FIGS. 1 to 8, the system may utilise any suitable tag and reader, and this is for the purpose of example only.

In the above described export process is an example procedure only, and that the steps involved may vary as required by law in the respective jurisdictions.

### Further Features

Some additional features/functionality of the system will now be described in more detail below.

### Tag Reading

It will be appreciated by a person skilled in the art that if an identity card is positioned on the inside of the car windscreen in the normal manner the presence of glass can reduce the effectiveness of read operations from the tag. In particular, it can be difficult for a reader 10 to successfully communicate with the tag 1 through the windscreen. In order to counteract the effects of this, the card can be modified as shown in FIG. 11 to include an expanded antenna 47 shown in dotted lines. The use of an expanded antenna disposed over a large portion of the identity card increases the effectiveness of communication between the reader 10 and the tag 1 thereby reducing the interference effects caused by the windscreen.

### Tag Encoding

It will also be appreciated by persons skilled in the art that as the identity card may be initially encoded in an office environment it is not generally necessary to encode the tag 1 utilising a handheld reader and desktop readers can be used.

In this instance, this allows specially configured readers to be used to provide modified data writing techniques. In particular, as the tag is provided in a label which is replaced on an annual basis, it is feasible to utilise a WORM (write once read many) tag by disabling the ability of the processor 11 or the modulator 15 to write information to the tag data store. It will be appreciated from this, that in one example, the modulator provided within the tag may not be provided with the ability to write data to the tag, with a modified reader 10 being used to provide the functionality of the modulator for writing purposes.

Furthermore, the use of a reading device with additional power can be utilised to successfully encode information even through a metallic portion of the label as discussed above.

### Vehicle Tracking

It will be appreciated that the vehicle information can be subsequently used in a variety of manners. For example, once the import process is complete, the vehicle information can be associated with a new tag that is permanently attached to the vehicle. This may then be used both to provide an audit trail as discussed above, as well as to identify the vehicle at any stage during the vehicle's life.

This can be used to identify the vehicle, for example in the event that the vehicle is stolen, or required for a recall, or the like. It can also be used to provide vehicle tracking for example, for use in issuing infringement notifications relating to speeding, parking tickets, or the like, as well as to allow for collection of road tolls.

The tag can also be used for example, allowing the tag to be used to register vehicles with an appropriate entity, such as a registration authority. In this example, the information written to the tag 1 can include details to identify the owner. In the event that asset is stolen, involved in an accident or the like, the tag can be used to determine the owner as required.

Accordingly, it will be appreciated by a person skilled in the art that the issuance of secret keys capable of decrypting the information stored on the asset registration tags is strictly controlled and limited to certain pre-authorised operators.

Entities which may be provided with authority to write and read information can include but is not limited to statutory authorities, Police, Law Enforcement Agencies, Finance Companies, Insurance Companies, Logistic Operators, Stock Controllers etc., depending on the circumstances in which the system is used.

Thus, for example the tags may be used to register vehicles with a Road Traffic Authority. In this particular instance the RFID tag may be provided as an integral part of a registration sticker which is placed on the windscreen of the vehicle. It will be appreciated that this can apply to any vehicle such as cycles, vessels, ships, aircraft and other vehicles that are required to be registered and have labels displayed detailing the relevant information of the registered vehicle.

In one example, the vehicle information can include the license number of the vehicle, the name and address of the operator or owner of the vehicle and additional information, such as the date of expiry of the registration, the date of the last vehicle check, MOT or the like. When the registration of the vehicle is renewed, for example on an annual basis, the vehicle information is checked, associated with a new identifier, which is then encoded in the tag provided on a new registration sticker.

In this example, the vehicle information can also be used in issuing infringement notifications, such as speeding tickets, parking fines or the like. In this case the reader 10 can execute applications software that allows vehicle information to be reviewed, and infringement notices to be issued. Thus, the operator will also be presented with a list of potential options such as issuing a speeding ticket, issuing a parking fine or the like, depending on the use of the reader 10. The operator will then select an appropriate option and this will cause the ticket to be issued.

This may be achieved in a number of ways. For example, the reader 10 can communicate with the remote computer system 30 transferring the car owner's detail to the computer system allowing the infringement notification to be issued by the computer system 30. This may be achieved for example by printing a notification and posting this in the normal way. Alternatively the reader 10 can be coupled to a printer via the external interface 17.

A further use of the tag is to allow information regarding unpaid infringements, or details of past traffic infringements to be stored. For example, if a driver is prosecuted related to a traffic offence, this information could be written to the remote database as part of the vehicle information. As a result, if the vehicle is involved in a traffic incident, the police can access the information stored on the tag and use this to assess if the driver has previous traffic violations, and take appropriate actions.

Similarly, the tag could be used to encode details of unpaid parking fines or the like. In this instance, if a parking inspector inspects the vehicle, for example during normal parking monitoring procedures, and determines that outstanding fines are in place, this will alert the inspector that action needs to be taken. In this case, the action could include, for example arranging for the vehicle to be towed or clamped until the outstanding fines are paid. In this case, as fines may have been paid after the registration label is issued, the inspector would generally check with a centralized and up to date database to see if action is required. This does however alert the inspector to the fact that further investigations are required.

As an additional function, it is desirable in many cases to have RFID tags 1 attached to the vehicle itself so that they are not provided on a sticker. This may include for example locating RFID chips at a number of different locations on the vehicle thereby allowing additional checks to be performed. This allows information such as the vehicle VIN, chasse number, or the like to be encrypted on the tag and stored. This allows additional test of vehicles to be performed by appropriate authorities.

### UV Marking

In order to assist with the identification of tags encoded and readable using the above described techniques, it is useful to provide UV fluorescent trace indicators on items which have an associated tag. The purpose behind this is it can be difficult to locate tags by simply positioning the reader 10 in close proximity to an item. In particular, reading of tags 1 can be effected by intervening materials positioned between the antennas 2, 16, such as metals or the like, which may effect the inductive properties of the tuned circuit. Thus, failure to read information may be cause either by the absence of a tag or by an invalid read.

Accordingly, items which are provided with a tag are typically marked with UV fluorescent ink, or the like. The readers 10 can then include an optional black light source which causes the UV markings to fluoresce thereby allowing objects having a tag to be identified.

### Secondary Database

As described above, the system includes the ability to write information to and read information from a secondary remote database, such as the database 36. It will be appreciated that this may be achieved in a number of manners.

For example, interaction with the database may be achieved solely through the use of the computer system, or alternative by providing appropriate communications within the reader 10. Depending on the implementation, this may use a database connected to a communications network, such as the Internet, or a private LAN or the like.

In this case, the unique identifier might be a numeric reference to a particular database entry, or alternatively may be indicative of additional information, such as the respective database used. Thus, for example, the identifier could include a network address at which the database is provided, or alternatively may direct the reader 10 to a suitable LUT (look-up table) which provides details of the database.

### Antenna

In general the antenna 16 will be provided within the housing 21. This is feasible because the housing is formed from plastic which has a negligible effect on the properties of the tuned circuit, and can be easily accounted for the circuit configuration.

However, in some circumstances the RFID tags may be provided in a location that is difficult to read utilising such an antenna. For example when the RFID tags are incorporated into bikes it is typical to place the RFID tag within the bike frame. As the reader 10 is unable to communicate with the tag through the metal bike frame, it is therefore difficult to read the tag information correctly. Accordingly, the antenna may be in the form of a telescopic antenna which can be inserted into the frame of the bike. This ensures optimal inductive coupling between the antenna 16 and the antenna 2 thereby ensuring reading occurs correctly.

### Communications

Communication with the computer system may be achieved using a number of different techniques, including wired connections, such as an RS232 connection, a USB connection, or the like. Thus, in one example, 10 pin RJ 45 connector is provided on the bottom of the handle 22 to allow full duplex communication between the reader 10 and the computer system 30. However, alternatively, or additionally, wireless connections, such as Bluetooth or Zigbee can be used.

Furthermore, the reader 10 may be provided with GPRS functions and capabilities to allow wireless connectivity to the Internet or other communications networks.

### Display

The reader 10 includes a display such as a 112×64 pixel monochrome or colour graphics display which can be scrolled by pressing an associated input button. In this case, the display will provide general status information, as well as feedback during entry of information, authentication, and during the read process.

For example, if the trigger 13A is actuated then a message “READING TAG” will appear on the display until the tag is read, whereupon the information stored on the tag 1 will appear. An input button can be used to scroll through or otherwise review the information. In the event that no tag 1 can be detected, a “NO TAG FOUND” message can be displayed until the trigger is actuated again and the read cycle is repeated.

### Printer

A built in printer function or transmission capability of information to a printer from a serial port is typically implemented by the processor 11, allowing information from tags, or other information, to be printed. Alternatively, or additionally, a printer may be incorporated into the housing 20.

### Additional Visual & Aural Feedback

A speaker and/or additional visual indicators, such as an LED 14A may be used to provide additional feedback to an operator. For example, an audible sound can be generated when the reader 10 is connected to a computer system 30, or during a read process. A dual colour LED 14A can turn green when reading the tag, with the LED turning red when writing to the tag.

### Multiple Tags

The system can be adapted to write to multiple tags, such that the information and key selection process need only be performed a single time. In this case, software can prompt for the number of tags to be programmed which will then allow successive actuations of the trigger until all tags are programmed after which the next trigger will cause the gun to revert to read only mode, and purge the memory 12.

### Power Supply

When connected to the computer system, for example via a USB connection, power for the reader 10 can be drawn from the computer 30. Otherwise a battery will be provided such as 9 volt alkaline battery. Alternately an AC power supply can be used. To save power, the reader will typically turn on automatically if the trigger or the scroll button is actuated and automatically turn off if not used for 3 minutes.

### Encryption

In one example, vehicle information to be encrypted is encrypted using 128 bit AES encryption, for example based on a 64 bit secret key. Each reader 10 will typically be capable of storing a number of secret keys enabling the reader to be used for a corresponding number of different applications.

In one example, the encryption system uses a Unique ID of the tag 1, determined during the initial detection of the tag 1, and combines this with the secret key of the Reader/Writer to create a “hash” key based on the encryption algorithm. This means that only a device with the correct secret key and encryption algorithm will be able read and decipher the tag.

As previously mentioned dissemination of the secret keys can be restricted to control access to the information, thereby helping to ensure appropriate security of the information stored on the tags. In order to control dissemination of the tags an authority may be to supply secret keys, with it being necessary for the owners of the readers to undergo some form of authorization and authentication with the registration authority in order to be obtain the keys. The authority will then operate to record the secret key into the memory 12 of the tag reader 10, via a secure connection.

Alternatively the secret key may be generated locally, within the computer system 30, or the reader 10, again providing further control over dissemination.

However, use of a relevant authority allows common secret keys to be more easily provided to a number of readers. This allows different readers within an organisation, such as the Police force, to be programmed with the key centrally, thereby removing the burden from the Police force. Additionally, as some tags may want to be accessed via a number of different parties, in which case the authority may authorize the provision of the secret key to each party independently.

It will be appreciated from this that each secret key will typically associated with a respective type of information, or use scenario, examples of which will be described in more detail below. A further feature is that different encryption keys may be associated with different access levels. This provides additional security to information such that different users of the system are only able to decrypt different parts of the information.

### Remote Shutdown

In order to further prevent unauthorised use of the system it is possible for the readers 10 to incorporate a remote shutdown system. In particular, the remote shutdown system may be used in the event that a reader 10 is stolen. In this particular instance the reader 10 will typically include GPRS functionality or similar to allow wireless communication to be performed with a remote computer system. In this case, when a reader 10 is reported stolen the remote computer system can transfer predetermined commands to the reader 10 causing the processor 11 to shutdown the reader 10 and purge the contents of the memory 12, thereby deleting any secret keys contained, and preventing further use of the device.

Additionally, the reader 10 may include a GPS system to allow the location of the reader 10 to be monitored, which in turn allows lost or stolen readers 10 to be recovered.

### User Authentication

The nature of the operator ID can vary depending on the model of the reader 10, and the level of security desired. The ID could include, for example, a PIN (Personal Identification Number), a password, a biometric signature of the operator, or the like. The manner in which the ID is generated and provided to the reader 10 will depend on the authentication mechanism used but may include for example scanning a thumb print to generate a biometric signature, entering a PIN number using the input 13, or the like.

### Monolithic IC

It is possible for the processor 11 and the memory 12 provided in the reader 10 to be formed on a monolithic IC. The use of the monolithic IC avoids the need to transfer secret keys via the bus 19 which can represent a point of weakness in the security of the system.

In particular, if a reader 10 is stolen, then it is possible to monitor signals transferred via the bus 19 and use these to determine the secret keys stored within the device. The secret keys can then be used to decrypt the information provided on tags. However by utilising a monolithic IC all transfer of the secret key is internal within a single chip and is therefore virtually impossible to derive by outside measurement of signals.

### Read/Write Details

It is possible to encode information regarding the write and read processes, either within the tag 1, or the remote database 36. For example, it is possible to utilise time stamping to record either when information is written to a tag 1 or read from the tag 1. In the former case the time stamp is typically included within the encoded data so that it may not be subsequently modified. The time stamp can then be used for a number of purposes, such as to indicate expiry dates of the information. In this later case as there is only limited space on a tag and a significant number of read events may occur, each time a tag is read the reader 10 is adapted to provide an indication of the unique tag 1D to the remote database 36 which then stores this together with a time stamp indicating when the device tag was read. The information may also include personal information regarding the operator of the reader 10 such that the user of the reader 10 can be subsequently identified.

### Example Uses

It will be appreciated by persons skilled in the art that the above described process can also be modified for use in other circumstances, and in particular to any vehicle transfer, sale, or registration. Thus, whilst the example is specific to vehicle registration, the process can be modified to provide an audit trail of any post manufacture events relating to the car.

Thus, the tag stores a large amount of information that can be subsequently used in a variety of manners. Thus in addition to providing registration information as discussed above, the information may be used to identify the vehicle at any stage during the vehicle's life.

As an additional function, it is desirable in many cases to have RFID tags 1 embedded within the asset itself so that they are not provided on a sticker. This may include for example locating RFID chips at a number of different locations on the vehicle thereby allowing additional checks to be performed. This allows information such as the vehicle VIN, chasse number, or the like to be encrypted on the tag and stored. This allows additional test of vehicles to be performed by appropriate authorities.

Persons skilled in the art will appreciate that numerous variations and modifications will become apparent. All such variations and modifications which become apparent to persons skilled in the art, should be considered to fall within the spirit and scope that the invention broadly appearing before described.

1. A method of tracking a vehicle during a transfer process, the transfer process including one or more stages, the method utilizing a tag having a tag data store, and wherein the method includes:
a) in a tag reader:
i) determining an identifier from the tag data store;
ii) determining, using the identifier, transfer information at least partially indicative of:
(1) an identity of the vehicle; and,
(2) a status of the transfer process; and,
b) using the transfer information, to at least one of:
(1) locate the vehicle;
(2) confirm that a stage in the transfer process is to proceed; and,
(3) determine the status of the transfer.

2. A method according to claim 1, wherein the identifier is at least one of:
a) the vehicle identity; and,
b) a reference number mapped to the vehicle identity.

3. A method according to claim 1, wherein the method includes, in the tag reader, determining the transfer information from at least one of:
a) a remote database; and,
b) the tag data store.

4. A method according to claim 1, wherein the tag forms part of an identity card provided in the vehicle.

5. A method according to claim 1, wherein the method includes, in the tag reader:
a) determining, using the identifier and from a remote database, the transfer information; and,
b) displaying the transfer information.

6. A method according to claim 1, wherein the vehicle is stored in a storage location, and wherein the method includes, in the tag reader:
a) receiving an indication of a vehicle identity;
b) determining the identifier associated with the vehicle identity; and,
c) detecting the tag using the determined identifier to thereby locate the vehicle.

7. A method according to claim 6, wherein the method includes, in the tag reader:
a) adjusting a read range of the tag reader;
b) determining if the identifier can be read from any tags within the read range; and,
c) repeating steps a) and b) to thereby locate the tag.

8. A method according to claim 1, wherein the method includes, in the tag reader:
a) determining from user input, an updated status; and,
b) updating the transfer information based on the updated status.

9. A method according to claim 1, wherein the method includes, performing a stage in the transfer process by:
a) using the tag reader to:
i) locate the vehicle; and,
ii) display the transfer information;
b) performing a clearance inspection, at least in part by comparing at least one of the vehicle and the transfer information to clearance criteria; and,
c) in response to a successful clearance, performing at least one of:
i) updating the transfer information using the tag reader;
ii) continuing the vehicle transfer process; and,
iii) returning the vehicle a storage location and updating the transfer information with the new location.

10. A method according to claim 9, wherein the method includes, in a processing system, updating the transfer information by adding details of at least one of:
a) a clearance number;
b) an agent identity;
c) an inspection date;
d) an inspection time;
e) an inspection number;
f) any clearance restrictions;
g) an intended destination; and,
h) details of required modifications.

11. A method according to claim 1, wherein the method includes, in a processing system:
a) determining completion of the transfer process; and,
b) disassociating the tag and the vehicle in response to a successful determination.

12. A method according to claim 1, wherein the method includes, in a processing system, causing the transfer information to be locked as it is stored or updated.

13. A method according to claim 12, wherein the method includes, locking the information at least in part by encrypting the transfer information such that the transfer information can only be decrypted using a secret key.

14. A method according to claim 1, wherein the method includes, in a tag reader:
a) determining an operator identifier indicative of an identity of an operator;
b) authenticating the operator using the operator identifier; and,
c) in response to a successful authentication, at least one of:
i) determining the identifier;
ii) determining the transfer information; and,
iii) modifying the transfer information.

15. A method according to claim 14, wherein the method includes, in the tag reader:
a) receiving the operator identifier from the operator;
b) comparing the operator identifier to a number of predetermined operator identifiers stored in a data store; and,
c) authenticating the operator in response to a successful comparison, wherein the operator identifier includes at least one of:
i) a biometric signature;
ii) a password; and,
iii) a PIN.

16. A method according to claim 14, wherein the method includes, in the tag reader:
a) determining from the transfer information at least one transfer information access level;
b) determining, using the operator identifier and from operator details stored in a data store, one or more operator access levels;
c) comparing the transfer information access levels to the operator access levels; and,
d) selectively displaying the transfer information in accordance with the results of the comparison.

17. A method according to claim 16, wherein the transfer information includes:
a) a payload, the payload including the transfer information encrypted using a secret key; and,
a header, the header being indicative of the secret key, and wherein method includes, in the tag reader:
i) determining, from the header, an indication of the secret key;
ii) obtaining the secret key from a data store using the secret key indication; and,
iii) decrypting the payload using the secret key.

18. A method according to claim 1, wherein the tag is an RFID tag, and wherein the method includes, in the tag reader, determining the identifier by:
a) generating a read signal, the tag being responsive to the read signal to modulate the read signal in accordance with the identifier;
b) detecting modulation of the read signal; and,
c) determining the identifier using the detected modulation.

19. Apparatus for tracking a vehicle during a transfer process, the transfer process including one or more stages and utilizing a tag having a tag data store, and wherein the apparatus includes a tag reader for:
a) determining an identifier from the tag data store;
b) determining, using the identifier, transfer information at least partially indicative of an identity of the vehicle and a status of the transfer process, wherein the transfer information is used to at least one of:
i) locate the vehicle;
ii) confirm that a stage in the transfer is to proceed; and,
iii) determine the status of the transfer.

20. A method of tracking a vehicle during a transfer process, the transfer process including one or more stages, the method utilizing a tag having a tag data store, the method including:
a) in a processing system:
i) storing transfer information, the transfer information being at least partially indicative of:
(1) an identity of the vehicle; and,
(2) a status of the transfer process;
ii) associating a tag with the vehicle using an identifier stored in the tag data store; and,
b) providing the tag with the vehicle, such that at one or more selected stages during the transfer process, the tag can be used to determine the transfer information using the identifier from the tag data store, the transfer information being at least one of:
(1) used to locate the vehicle;
(2) reviewed so as to confirm that a stage in the transfer is to proceed; and,
(3) used to determine the status of the transfer.

21. A method according to claim 20, wherein the identifier is the vehicle identity.

22. A method according to claim 20, wherein the method includes, in the processing system, associating the tag with the vehicle by recording a mapping between the vehicle identity and the unique identifier.

23. A method according to claim 20, wherein the method includes, in the processing system, storing the transfer information in at least one of:
a) a remote database; and,
b) the tag data store.

24. A method according to claim 20, wherein the method includes, in the processing system, causing the identifier to be written to the tag data store.

25. A method according to claim 20, wherein the tag forms part of an identity card adapted to be coupled to the vehicle, and wherein the method includes, in the processing system, causing the printing of at least the identifier on the identity card.

26. A method according to claim 20, wherein the vehicle is stored in a storage location, and wherein the method includes, in the processing system, storing location information indicative of a vehicle location within the storage location as part of the transfer information.

27. A method according to claim 20, wherein the method includes, in the processing system, causing the transfer information to be locked as it is stored or updated.

28. A method according to claim 27, wherein the method includes, locking the information at least in part by encrypting the information such that the information can only be decrypted using a secret key.

29. Apparatus for tracking a vehicle during a transfer process, the transfer process including one or more stages, the method utilizing a tag having a tag data store, the apparatus including in a processing system for:
i) storing transfer information, the transfer information being at least partially indicative of:
(1) an identity of the vehicle; and,
(2) a status of the transfer process; and,
ii) associating a tag with the vehicle using an identifier stored in the tag data store, the tag being provided with the vehicle, such that at one or more selected stages during the transfer process, the tag can be used to determine the transfer information using the identifier from the tag data store, the transfer information being at least one of:
(1) used to locate the vehicle;
(2) reviewed so as to confirm that a stage in the transfer is to proceed; and,
(3) used to determine the status of the transfer.

30. Apparatus according to claim 31, wherein the processing system forms part of a tag reader.

31. A method of tracking a vehicle during a transfer process, the transfer process including one or more stages, the method including:
a) associating the vehicle with a tag having an identifier stored in a tag data store;
b) using the tag to:
i) access transfer information at least partially indicative of:
(1) an identity of the vehicle; and,
(2) a status of the transfer process; and,
ii) track the vehicle through the one or more stages; and,
c) disassociating the vehicle and the tag, thereby allowing the tag to be associated with a subsequent vehicle for transfer.

32. A method according to claim 31, wherein the method includes, at least one of:
a) associating the tag with a vehicle by recording a mapping between the unique identifier and the transfer information; and,
b) disassociating the tag with a vehicle by deleting a mapping between the unique identifier and the transfer information.

33. A method according to claim 31, wherein the method includes, performing a stage in the transfer process by:
a) using a tag reader to:
i) locate the vehicle; and,
ii) display the transfer information;
b) performing a clearance inspection, at least in part by comparing at least one of the vehicle and the transfer information to clearance criteria; and,
c) in response to a successful clearance, performing at least one of:
i) updating the transfer information using the tag reader;
ii) continuing the vehicle transfer process; and,
iii) returning the vehicle a storage location and updating the transfer information with the new location.

36. (canceled)

34. A method for use in a vehicle during a transfer process, the transfer process including one or more stages, the method utilizing a tag having a tag data store, and wherein the method includes:
a) using a tag reader to:
i) locate the vehicle; and,
ii) display the transfer information;
b) performing a clearance inspection, at least in part by comparing at least one of the vehicle and the transfer information to clearance criteria; and,
c) in response to a successful clearance, performing at least one of:
i) updating the transfer information using the tag reader;
ii) continuing the vehicle transfer process; and,
iii) returning the vehicle a storage location and updating the transfer information with the new location.

38. (canceled)
